(19) United States
(12) Patent Application Publication
(10) Pub. No.: US 2026/0133927 A1
(43) Pub. Date: May 14, 2026

(54) CONNECTOR AND MOTHERBOARD

(71) Applicant: ASRock Industrial Computer Corporation, Taipei City (TW)

(72) Inventor: Yao Ting Huang, Taipei City (TW)

(73) Assignee: ASRock Industrial Computer Corporation, Taipei City (TW)

(21) Appl. No.: 19/310,587

(22) Filed: Aug. 26, 2025

(30) Foreign Application Priority Data
Nov. 11, 2024 (TW) 113212249

(51) Int. Cl. G06F 13/40; G06F 13/42

(52) U.S. Cl. CPC G06F 13/4027; G06F 13/4282; G06F 2213/0026; G06F 2213/0042

(57) ABSTRACT

A connector and a motherboard are provided. The connector is disposed on the motherboard. The connector includes a plurality of first pins and a plurality of second pins. The first pins are configured to transmit and receive a plurality of first signals corresponding to a basic functional interface. The second pins are configured to transmit and receive a plurality of second signals corresponding to an expansion functional interface. The first pins are distributed in a first area of the connector, and the second pins are distributed in a second area of the connector. The first area is different from the second area.

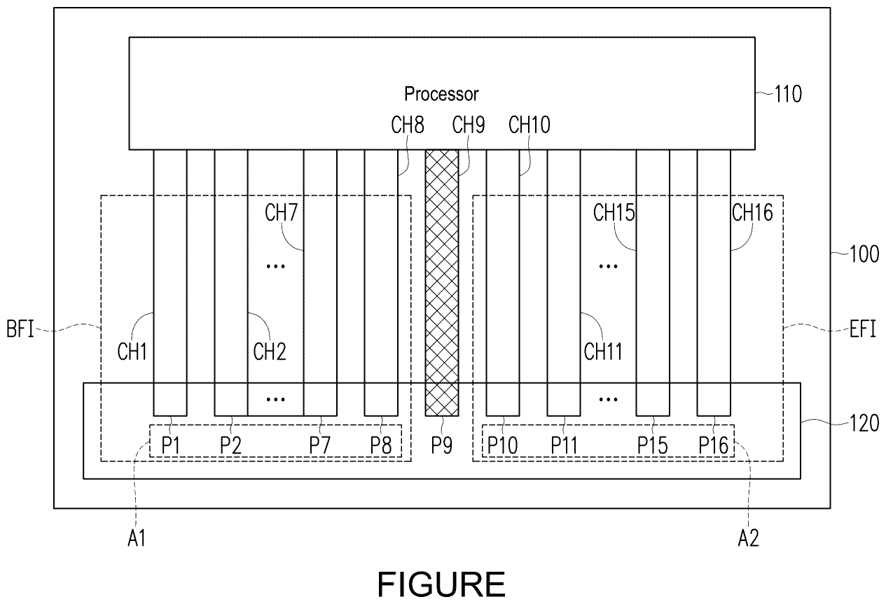

### CROSS-REFERENCE TO RELATED APPLICATION

This application claims the priority benefit of Taiwan patent application no. 113212249, filed on Nov. 11, 2024. The entirety of the above-mentioned patent application is hereby incorporated by reference herein and made a part of this specification.

### BACKGROUND

### Technical Field

The disclosure relates to an electrical connector technology and particularly relates to a connector with an expansion function and a motherboard.

### Description of Related Art

In current computer technology, PCI express (PCIe) standard is a common bus specification on computer motherboards and mainly serves to connect various computer hardware equipment. Among various PCIes, the PCIe X8 fifth generation (Gen5) interface can support external independent graphics cards or M.2 high-speed storage hard drives, whereby the operation performance of the motherboard is enhanced, and stable and efficient data or signal transmission is provided.

However, in the PCIe X8 Gen5 interface on conventional motherboards, designers can often merely use PCIe X8 connectors to perform data or signal transmission, and the PCIe X8 connectors can simply transmit data or signals that comply with the PCIe X8 Gen5 transmission standard. In this situation, for industrial computers, an insufficient expandability issue may occur. If additional input/output interfaces are to be added to or expanded on the motherboards, the computer systems inevitably have to adopt additional connectors, thereby increasing the size and hardware cost of the motherboards.

### SUMMARY

The disclosure provides a connector and a motherboard, whereby the expandability of the motherboard can be improved through transmitting and receiving a plurality of first signals corresponding to a basic functional interface and transmitting and receiving a plurality of second signals corresponding to an expansion functional interface.

According to an embodiment of the disclosure, a connector disposed on a motherboard is provided. The connector includes a plurality of first pins and a plurality of second pins. The first pins are configured to transmit and receive a plurality of first signals corresponding to a basic functional interface. The second pins are configured to transmit and receive a plurality of second signals corresponding to an expansion functional interface. The first pins are distributed in a first area of the connector, and the second pins are distributed in a second area of the connector. Here, the first area is different from the second area.

According to an embodiment of the disclosure, a motherboard is provided, and the motherboard includes a processor, a connector, a plurality of first transmission channels, and a plurality of second transmission channels. The connector has a plurality of first pins and a plurality of second pins. The first transmission channels are coupled between the processor and the first pins. The second transmission channels are coupled between the processor and the second pins. The first pins and the first transmission channels of the connector are set as a basic functional interface, and the second pins and the second transmission channels of the connector are set as an expansion functional interface.

Based on the above, the connector and the motherboard provided in one or more embodiments of the disclosure can transmit and receive the first signals corresponding to the basic functional interface and transmit and receive the second signals corresponding to the expansion functional interface through the connector having 16 pins and 16 transmission channels without affecting the operation of the original PCIe X8 Gen5 interface, whereby input/output interfaces commonly used by the computer system are expanded. As such, the connector and the motherboard provided in one or more embodiments of the disclosure can effectively enhance the expandability, whereby the performance of the computer system is improved.

To make the above more comprehensible, several embodiments accompanied with a drawing are described in detail as follows.

### BRIEF DESCRIPTION OF THE DRAWING

The accompanying drawing is included to provide a further understanding of the disclosure, and is incorporated in and constitute a part of this specification. The drawing illustrates embodiments of the disclosure and, together with the description, serves to explain the principles of the disclosure.

FIGURE is a schematic diagram illustrating a motherboard according to an embodiment of the disclosure.

### DESCRIPTION OF THE EMBODIMENTS

FIGURE is a schematic diagram illustrating a motherboard 100 according to an embodiment of the disclosure. With reference to FIGURE, the motherboard 100 includes a processor 110, a connector 120, and a plurality of transmission channels CH1 to CH16. The connector 120 may be disposed on the motherboard 100. The connector 120 includes pins P1 to P16. For instance, the connector 120 provided in this embodiment may be, for instance, a connector having 16 pins and 16 transmission channels.

Particularly, in this embodiment, the pins P1 to P8 may be distributed in a first area A1 of the connector 120, and the pins P10 to P16 may be distributed in a second area A2 of the connector 120. The first area A1 is different from the second area A2. In addition, the pin P9 of the connector 120 may be set as a floating pin, and the floating pin (i.e., the pin P9) may be disposed between the first area A1 and the second area A2.

In another aspect, in this embodiment, transmission channels CH1 to CH8 are coupled between the processor 110 and the pins P1 to P8. For instance, the transmission channel CH1 may be coupled between the processor 110 and the pin P1, whereby the pin P1 of the connector 120 may transmit or receive corresponding signals through the transmission channel CH1. Besides, the transmission channel CH2 may be coupled between the processor 110 and the pin P2, whereby the pin P2 of the connector 120 may transmit or receive corresponding signals through the transmission channel CH2. The other transmission channels CH3 to CH8 and the pins P3 to P8 may be deduced from the above.

Additionally, transmission channels CH10 to CH16 are coupled between the processor 110 and the pins P10 to P16. For instance, the transmission channel CH10 may be coupled between the processor 110 and the pin P10, whereby the pin P10 of the connector 120 may transmit or receive corresponding signals through the transmission channel CH10. Besides, the transmission channel CH11 may be coupled between the processor 110 and the pin P11, whereby the pin P11 of the connector 120 may transmit or receive corresponding signals through the transmission channel CH11. The other transmission channels CH12 to CH16 and the pins P12 to P16 may be deduced from the above.

Regarding the implementation details of the motherboard 100 shown in FIGURE, specifically, according to this embodiment, the pins P1 to P8 of the connector 120 (i.e., the first pins P1 to P8) and the transmission channels CH1 to CH8 (i.e., the first transmission channels CH1 to CH8) may be set as a basic functional interface BFI of the motherboard 100.

In addition, the basic functional interface BFI provided in this embodiment may be an input/output interface that complies with the transmission standard of PCIe X8 Gen5. For instance, the connector 120 provided in this embodiment may receive a plurality of signals (i.e., a plurality of first signals) that comply with the PCIe X8 Gen5 transmission standard from an external device through the pins P1 to P8. Then, the connector 120 may transmit the signals corresponding to the basic functional interface BFI (i.e., the PCIe X8 Gen5 interface) to the processor 110 through the transmission channels CH1 to CH8, whereby the processor 110 may perform related operations according to these first signals.

In another aspect, according to this embodiment, the pins P10 to P16 of the connector 120 (i.e., the second pins P10 to P16) and the transmission channels CH10 to CH16 (i.e., the second transmission channels CH10 to CH16) may be set as an expansion functional interface EFI of the motherboard 100.

Besides, the expansion functional interface EFI provided in this embodiment may be an input/output interface that complies with universal serial bus (USB) 3.2, USB2.0, inter-integrated Circuit (I2C), universal asynchronous receiver/transmitter (UART), and/or general-purpose input/output (GPIO) transmission standards.

For instance, in the expansion functional interface EFI of the connector 120, the connector 120 may receive differential signals (i.e., a plurality of second signals) that comply with the USB3.2 transmission standard from an external device through the pins P10 and P11. Then, the connector 120 may transmit the differential signals corresponding to the expansion functional interface EFI (i.e., the USB3.2 interface) to the processor 110 through the transmission channels CH10 to CH11, whereby the processor 110 may perform related operations according to the differential signals.

For instance, in the expansion functional interface EFI of the connector 120, the connector 120 may receive the differential signals (i.e., a plurality of second signals) that comply with the USB 2 transmission standard from an external device through the pins P12 and P13. Then, the connector 120 may transmit the differential signals corresponding to the expansion functional interface EFI (i.e., the USB2 interface) to the processor 110 through the transmission channels CH12 and CH13, whereby the processor 110 may perform related operations according to the differential signals.

For instance, in the expansion functional interface EFI of the connector 120, the connector 120 may receive an I2C signal (i.e., a second signal) that complies with the I2C transmission standard from an external device through the pin P14. Then, the connector 120 may transmit the I2C signal corresponding to the expansion functional interface EFI (i.e., the I2C interface) to the processor 110 through the transmission channel CH14, whereby the processor 110 may perform related operations according to the I2C signal.

For instance, in the expansion functional interface EFI of the connector 120, the connector 120 may receive a UART signal (i.e., a second signal) that complies with the UART transmission standard from an external device through the pin P15. Then, the connector 120 may transmit the UART signal corresponding to the expansion functional interface EFI (i.e., the UART interface) to the processor 110 through the transmission channel CH15, whereby the processor 110 may perform related operations according to the UART signal.

For instance, in the expansion functional interface EFI of the connector 120, the connector 120 may receive a GPIO signal (i.e., a second signal) that complies with the GPIO transmission standard from an external device through the pin P16. Then, the connector 120 may transmit the GPIO signal corresponding to the expansion functional interface EFI (i.e., the GPIO interface) to the processor 110 through the transmission channel CH16, whereby the processor 110 may perform related operations according to the GPIO signal.

It is worth mentioning that when the connector 120 transmits and receives a plurality of first signals corresponding to the basic functional interface BFI (i.e., signals corresponding to the PCIe X8 Gen5 interface) through the pins P1 to P8, the motherboard 100 provided in this embodiment may maintain the pin P9 of the connector 120 in an open state to prevent the processor 110 from mistaking that the pins P9 to P16 are continuously transmitting or receiving signals corresponding to the PCIe X8 Gen5 interface, which may cause communication errors in the motherboard 100. Under this foolproof design provided in this embodiment, the motherboard 100 may interrupt the signals corresponding to the PCIe X8 Gen5 interface at the pin P9 and the transmission channel CH9, thereby separating the basic functional interface BFI from the expansion functional interface EFI and preventing the communication errors in the motherboard 100.

Given that the conventional motherboards with the PCIe X8 Gen5 interface may only utilize PCIe X8 Gen 5 connectors to transmit data or signals complying with the PCIe X8 Gen5 transmission standard, computer systems may suffer from insufficient expandability. The motherboard 100 provided in this embodiment addresses this limitation by integrating the commonly used computer system input/output interfaces (i.e., the expansion functional interface EFI) within one single connector 120 while maintaining full operation of the original PCIe X8 Gen5 interface (i.e., the basic functional interface BFI). Consequently, the motherboard 100 provided in this embodiment may effectively enhance expandability, thereby improving overall computer system performance.

To sum up, the connector and the motherboard provided in one or more embodiments of the disclosure can transmit and receive the first signals corresponding to the basic functional interface and transmit and receive the second signals corresponding to the expansion functional interface through the connector having 16 pins and 16 transmission channels without affecting the operation of the original PCIe X8 Gen5 interface, whereby the commonly used computer system input/output interfaces are expanded. As such, the connector and the motherboard provided in one or more embodiments of the disclosure can effectively enhance expandability, thereby improving overall computer system performance.

It will be apparent to those skilled in the art that various modifications and variations may be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A connector, disposed on a motherboard and comprising:
a plurality of first pins, configured to transmit and receive a plurality of first signals corresponding to a basic functional interface; and
a plurality of second pins, configured to transmit and receive a plurality of second signals corresponding to an expansion functional interface, wherein the plurality of first pins are distributed in a first area of the connector, and the plurality of second pins are distributed in a second area of the connector, wherein the first area is different from the second area.

2. The connector according to claim 1, wherein the expansion functional interface complies with universal serial bus 3.2, universal serial bus 2.0, inter-integrated circuit, universal asynchronous receiver/transmitter, and general-purpose input/output transmission standards.

3. The connector according to claim 1, wherein the basic functional interface complies with a PCI Express fifth generation transmission standard.

4. The connector according to claim 1, wherein the connector further comprises at least one floating pin, and the at least one floating pin is distributed between the first area and the second area.

5. A motherboard, comprising:
a processor;
at least one connector, having a plurality of first pins and a plurality of second pins;
a plurality of first transmission channels, coupled between the processor and the plurality of first pins; and
a plurality of second transmission channels, coupled between the processor and the plurality of second pins,
wherein the plurality of first pins and the plurality of first transmission channels of the at least one connector are set as a basic functional interface, and the plurality of second pins and the plurality of second transmission channels of the at least one connector are set as an expansion functional interface.

6. The motherboard according to claim 5, wherein the expansion functional interface complies with universal serial bus 3.2, universal serial bus 2.0, inter-integrated circuit, universal asynchronous receiver/transmitter, and general-purpose input/output transmission standards.

7. The motherboard according to claim 5, wherein the basic functional interface complies with a PCI Express fifth generation transmission standard.

8. The motherboard according to claim 5, wherein the plurality of first pins are distributed in a first area of the at least one connector, and the plurality of second pins are distributed in a second area of the at least one connector, wherein the first area is different from the second area.

9. The motherboard according to claim 8, wherein the at least one connector has at least one floating pin, and the at least one floating pin is distributed between the first area and the second area.
